(19) United States
(12) Patent Application Publication
(10) Pub. No.: US 2025/0324351 A1
(43) Pub. Date: Oct. 16, 2025

(54) DYNAMIC TUNING OF SYNCHRONIZATION SIGNAL BLOCK PERIODICITY, SIB 2,3,4,5 BROADCAST PERIODICITY AND TURN OFF DYNAMICALLY TO IMPROVE SYSTEM PERFORMANCE & CAPACITY

(71) Applicant: DISH Wireless L.L.C., Englewood, CO (US)

(72) Inventors: Karupaiah Rajendran, Sachse, TX (US); Norberto Amaya Gonzalez, San Diego, CA (US)

(21) Appl. No.: 18/637,350

(22) Filed: Apr. 16, 2024

(51) Int. Cl. H04W 48/10; H04W 24/08

(52) U.S. Cl. CPC H04W 48/10; H04W 24/08

(57) ABSTRACT

Technologies for dynamic tuning of signal periodicity in a cellular network are described. One method include monitoring a plurality of parameters associated with a base station in the cellular network, each parameter of the plurality of parameters characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station; dynamically generating, based on the plurality of parameters, a value of a periodicity parameter of a signal broadcasted by the base station of the cellular network; and applying the value of the periodicity parameter for transmission of the signal to a first UE of the plurality of UE.

### BACKGROUND

Cellular networks are highly complex. One type of cellular network is a fifth generation (5G) new radio (NR) cellular networks. 5G NR cellular networks have the promise to provide higher throughput, lower latency, and higher availability compared with previous global wireless standards. However, some parameters in a 5G NR cellular network cannot be modified dynamically, which may compromise such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing dynamic tuning of signal periodicity in a cellular network according to at least one embodiment.

FIG. 2 is a block diagram of a system including periodicity parameter manager that implements dynamic tuning of signal periodicity in a cellular network according to at least one embodiment.

FIG. 3A illustrates an example physical resource block (PRB) transmitted from a base station to a UE and FIG. 3B illustrates an example signal periodicity.

FIGS. 4, 5A, 5B, 6, and 7 are flow diagrams of example methods of dynamic tuning of signal periodicity in a cellular network according to at least one embodiment.

### DETAILED DESCRIPTION

Technologies for dynamic tuning of signal periodicity in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Some resource blocks used in the communication between user equipment and cellular network are reserved to carry signals broadcasted from the cellular network. For example, the cellular network may broadcast certain signals periodically. However, certain signals are not necessarily to be broadcasted frequently or at all, which may result in a waste of resource blocks usage.

Aspects and embodiments of the present disclosure address the above and other deficiencies by providing a system that implements dynamic tuning of signal periodicity in a cellular network. Specifically, a component of the cellular network (e.g., periodicity parameter manager) may monitor parameters associated with a base station in the cellular network. The base station (e.g., “gNodeB” or “gNB”) refers to a network element responsible for the transmission and reception of radio signals in one or more cells (or coverage areas) to or from user equipment (UE). The parameters associated with the base station may include one or more parameters characterizing: data demand associated with the base station, the number of user equipment (UE) connected to the base station, occurrence of radio link failure associated with the base station, the state of each user equipment (UE) connected to the base station, or a key performance indicator (KPI) of an infrastructure resource of the cellular network associated with the base station.

The data demand associated with the base station may include a prediction of data size at a specific time point, for example, based on historical data. The number of user equipment (UE) connected to the base station may include a count (e.g., in real-time) of UE connected to the base station. The occurrence of radio link failure associated with the base station may include a count (e.g., over a period) of radio link failures between UE and the base station. The state of UE may include idle mode or connected mode of the UE or the proximity (e.g., measured by distance) to the base station. The KPI of an infrastructure resource of the cellular network associated with the base station may include a measurement of the amount, the type, or the categories of radio resources consumed in processes performed by the base station.

The component of the cellular network may dynamically generate, based on the monitored parameters, a value of a periodicity parameter of a signal broadcasted by the base station of the cellular network. For example, the component of the cellular network may determine whether the monitored parameters satisfy a threshold criterion for generating a new value of a periodicity parameter of a signal broadcasted by the base station of the cellular network, and generate the value of the periodicity parameter of the signal responsive to determining that the monitored parameters satisfy the threshold criterion. In some implementations, the periodicity parameter of the signal comprises at least one of: periodicity of a synchronization signal block (SSB), periodicity of a channel status information reference signal (CSI-RS), or periodicity of an optional system information block such as system information block type 2 (SIB2), system information block type 3 (SIB3), system information block type 4 (SIB4), or system information block type 5 (SIB5).

In some implementations, the component of the cellular network may determine whether the signal is transmitted through a supplemental downlink channel connected to the UE. Responsive to determining that the signal is transmitted through a supplemental downlink channel, the component of the cellular network may dynamically, based on the monitored parameters, generate a value higher than a default value of periodicity of an SSB broadcasted by the base station or turn off broadcasting the SSB.

In some implementations, the component of the cellular network may determine whether the signal is transmitted through a primary (including downlink and uplink) channel connected to the UE. Responsive to determining that the signal is transmitted through a primary channel, the component of the cellular network may dynamically, based on the monitored parameters, increase a default value of periodicity of a SSB broadcasted by the base station.

In some implementations, the component of the cellular network may dynamically, based on the monitored parameters, generate a value higher than a preset value of periodicity of CSI-RS or turn off broadcasting CSI-RS. In some implementations, the component of the cellular network may dynamically, based on the monitored parameters, generate a value higher than a preset value of periodicity of SSB (or turn off broadcasting SSB) and a value higher than a preset value of periodicity of CSI-RS (or turn off broadcasting CSI-RS).

In some implementations, the component of the cellular network may dynamically, based on the monitored parameters, generate a value higher than a preset value of periodicity of at least one of SIB 2, SIB3, SIB 4, or SIB 5 or turn off broadcasting at least one of SIB 2, SIB3, SIB 4, or SIB 5.

The cellular network may apply the value of the periodicity parameter, as determined above, for transmission of the signal to the UE such that the resource blocks that are previously to be used to transmit SSB, SIB 2, SIB3, SIB 4, or SIB 5 can be used for transmission of user data or other data because of the reduced frequency on transmission of SSB, SIB 2, SIB3, SIB 4, or SIB 5.

Aspects and embodiments of the present disclosure can use monitoring and the real-time measurement context of the cellular network for dynamic control of one or more signal periodicity in the cellular network. Aspects and embodiments of the present disclosure can improve system performance and transmission capacity by providing more resource blocks to their downstream customers, such as for downloading.

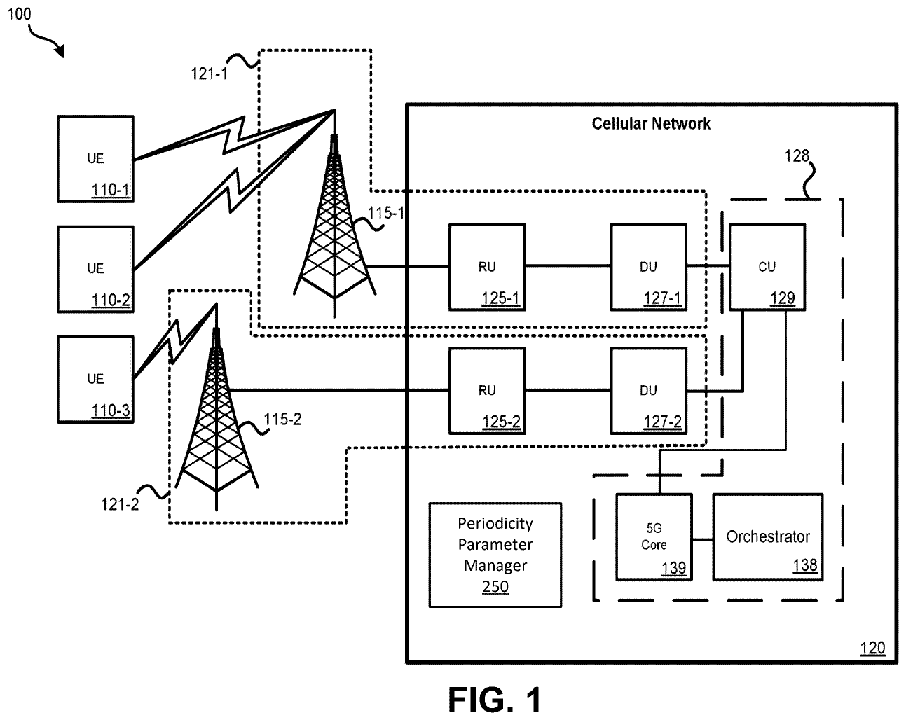

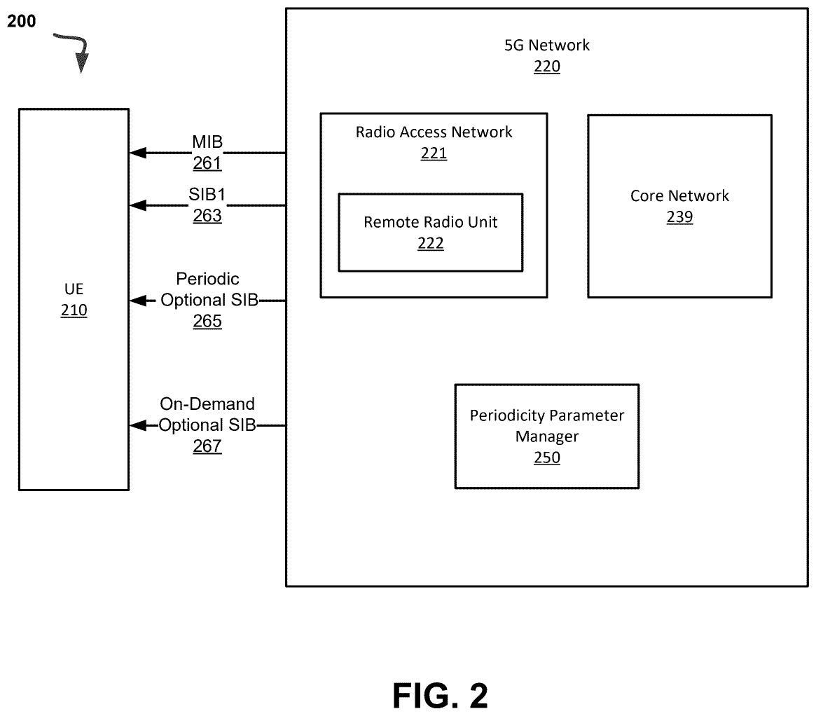

FIG. 1 illustrates an embodiment of a cellular network system 100A (“system 100A”). FIG. 1 represents an embodiment of a cellular network which can accommodate the cloud-based architecture of FIG. 2. System 100A can include a 5G New Radio (NR) cellular network; other types of cellular networks, such as 6G, 7G, etc. may also be possible. System 100A can include: UEs 110 (UE 110-1, UE 110-2, UE 110-3); base station 115; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QOS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating updating and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

In some embodiments, the cellular network 120 includes a periodicity parameter manager 123 that implements dynamic tuning of signal periodicity in a cellular network. In some embodiments, the periodicity parameter manager 123 is part of the base station(s). Further details regarding the operations of the periodicity parameter manager 123 are described below with reference to FIGS. 2-7.

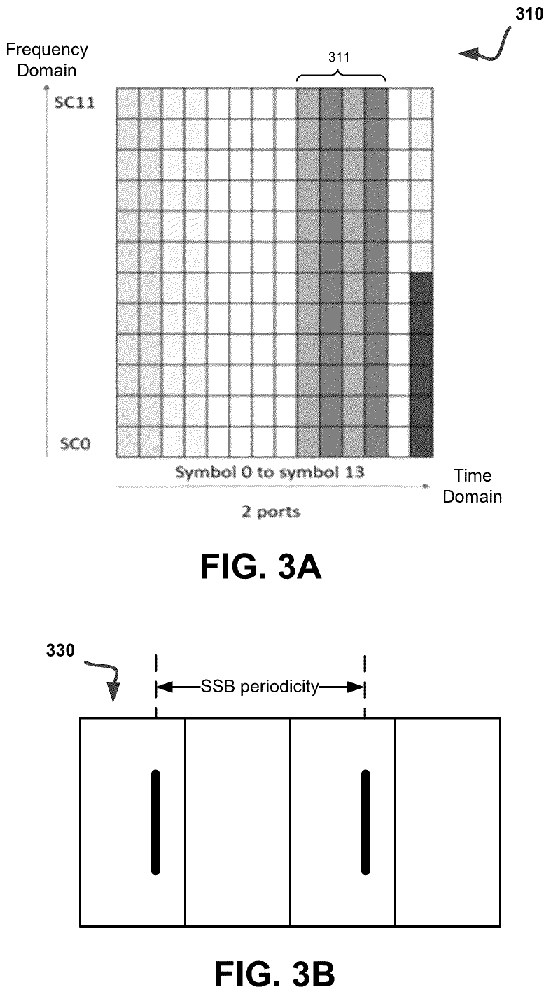

FIG. 2 is a block diagram of example periodicity parameter manager according to at least one embodiment. FIG. 3A illustrates examples of periodicity parameters and FIG. 3B illustrates example periodicity according to at least one embodiment. Referring to FIG. 2, a 5G network 220 includes a radio access network (RAN) 221 and a core network 239 according to at least one embodiment. In at least one embodiment, the 5G network 220 includes a periodicity parameter manager 250. In at least one embodiment, periodicity parameter manager 250 can be implemented in the RAN 221 and/or the core network 239.

The 5G network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the RAN 221 via a wireless connection. The UE 210 can include one of a number of UEs not depicted that are in communication with the RAN 1120. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

The RAN 221 includes a remote radio unit (RRU) 222 for wirelessly communicating with UE 210. The remote radio unit (RRU) 222 can include a Radio Unit (RU) and may include one or more radio transceivers for wirelessly communicating with UE 210. The remote radio unit (RRU) 222 may include circuitry for converting signals sent to and from an antenna of a Base Station into digital signals for transmission over packet networks. The RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210. The RAN 221 can include a new-generation radio access network (NG-RAN) that uses the 5G NR interface. In some embodiments, the distributed unit (DU) and the centralized unit (CU) of the RAN 221 may be co-located with the remote radio unit (RRU) 222. In other embodiments, the distributed unit (DU) and the remote radio unit (RRU) 222 may be co-located at a cell site and the centralized unit (CU) may be located within a local data center (LDC). The distributed unit (DU) can include a logical node configured to provide functions for the radio link control (RLC) layer, the medium access control (MAC) layer, and the physical layer (PHY) layers. The centralized units (CUs) can include a centralized unit for the user plane and a centralized unit for the control plane. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane can include a logical node configured to provide functions of the control plane part of the RRC and PDCP. The centralized unit for the user plane can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units 1220 can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RRU).

In some cases, the UE 210 may be capable of transmitting signals to and receiving signals from one or more RRUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mm Wave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF), the session management function (SMF), and the user plane function (UPF). The AMF may act as a single-entry point for a UE connection and perform mobility management, registration management, and connection management between a data network and UE. The AMF may interface with the SMF to track user sessions. The AMF may interface with a network slice selection function (NSSF) to select network slice instances for user equipment. When user equipment is leaving a first coverage area and entering a second coverage area, the AMF may be responsible for coordinating the handoff between the coverage areas whether the coverage areas are associated with the same radio access network or different radio access networks. The SMF may perform session management, user plane selection, and IP address allocation. The UPF may perform packet processing including routing and forwarding, quality of service (QOS) handling, and packet data unit (PDU) session management. The UPF may serve as an ingress and egress point for user plane traffic and provide anchored mobility support for user equipment. The UPF may be implemented as a software process or application running within a virtualized infrastructure or a cloud-based compute and storage infrastructure.

The UPF may transfer downlink data received from the data network to user equipment, via the RAN 221 and/or transfer uplink data received from user equipment to the data network via the RAN 221. An uplink can include a radio link though which user equipment transmits data and/or control signals to the RAN 221. A downlink can include a radio link through which the RAN 221 transmits data and/or control signals to the user equipment.

Uplink packets arriving from the RAN 221 may use a general packet radio service (GPRS) tunneling protocol (or GTP) to reach the UPF. The GPRS tunneling protocol for the user plane may support multiplexing of traffic from different PDU sessions by tunneling user data over the interface between the RAN 221 and the UPF. The UPF may remove the packet headers belonging to the GTP tunnel before forwarding the user plane packets towards the data network. As the UPF may provide connectivity towards other data networks in addition to the data network, the UPF must ensure that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the data network are mapped onto a specific Qos flow belonging to a specific PDU session before forwarded towards the appropriate RAN 221. A QoS flow may correspond with a stream of data packets that have equal quality of service (QOS). The PDU session may utilize one or more quality of service (QOS) flows to exchange traffic (e.g., data and voice traffic) between the UE 210 and the data network. The one or more QoS flows can include the finest granularity of QoS differentiation within the PDU session. The PDU session may belong to a network slice instance through the 5G network 220. To establish user plane connectivity from the UE 210 to the data network, an AMF that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

The 5G network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the radio access network (RAN) 221. User equipment, such as UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The 5G network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

FIG. 3A illustrates an example physical resource block (PRB) 310 transmitted from a base station to a first UE. The physical resource block 310 spans 12 subcarriers (SCO-SC11) corresponding to a frequency domain (e.g., 360 kHz), and the smallest time-frequency resource that can be scheduled to the first UE is one PRB pair mapped over 14 symbols (Symbol 0-Symbol 13) corresponding to a time domain (e.g., 1 ms for a subframe comprising several symbols). The small block in the PRB 310 can be referred to as resource element, and each resource element corresponds to one subcarrier over one symbol. The PRB 310 includes 168 resource elements. As shown in FIG. 3A, 48 resource elements are used to carry the synchronization signal block (SSB) 311.

SSB refers to synchronization signal/physical broadcast channel (PBCH) information because synchronization signal and PBCH information are packed as a single block that transmits together. The synchronization signal may include primary synchronization signal (PSS) and secondary synchronization signal (SSS). The PBCH information may include master information block (MIB). MIB may include the parameters that are required to decode system information type1 (SIB1). As shown in the graph 330 in FIG. 3B, the SSB may be transmitted with the periodicity of 20 ms (optionally 5 ms, 10 ms, 20 ms, 40 ms, 80 ms, or 160 ms).

Specifically, to enable the communication, both UE and base station in the communication needs to reach agreement on the common configuration, such as by using radio resource control (RRC) messages including SIB1. Referring to FIG. 2, to setup the initial connection between base station and UE, the base station may create a predefined synchronization signal and put the signal into a specific symbol in a specific subframe and broadcast to UE. The synchronization signal can be referred to as downlink synchronization signal and includes MIB 261 and SIB1 263. UE can decode MIB and use the decoded MIB to decode SIB1. SIB1 may include information of periodic optional SIBs 265 and on-demand optional SIBs 267, and the optional SIBs (265 or 267) may include system information block type 2 (SIB2), system information block type 3 (SIB3), system information block type 4 (SIB4), or system information block type 5 (SIB5). Periodic optional SIBs means that the base station can broadcast each of SIB2, SIB3, SIB4, and/or SIB5 with periodicity defined in SIB1. On-demand optional SIBs means that the base station can receive a request from UE and in response, broadcast the corresponding SIB2, SIB3, SIB4, and/or SIB5. In some implementations, the RRC messages include channel status information reference signal (CSI-RS), and CSI-RS is a special type of reference signal being transmitted by the base station for UE to use in order to estimate downlink radio channel quality.

The periodicity parameter manager 250 may monitor parameters associated with a base station in the 5G network 220. The base station (such as “gNodeB” or “gNB”) is a network element responsible for the transmission and reception of radio signals in one or more cells (or coverage areas) to or from UE 210. The parameters associated with the base station may include parameters characterizing: data demand associated with the base station, channel status information (CSI), antenna port configuration (e.g., CSI-RS (NZP (non-zero power) or ZP (zero power)), resource elements reserved for interference measurement (CSI-IM), the number of user equipment (UE) connected to the base station, occurrence of radio link failure associated with the base station, the state of each user equipment (UE) connected to the base station, or a key performance indicator (KPI) of an infrastructure resource of the cellular network associated with the base station. The data demand associated with the base station may include a prediction of data size at a specific time point, for example, based on historical data. The number of user equipment (UE) connected to the base station may include a (e.g., real-time) count of UE connected to the base station. The occurrence of radio link failure associated with the base station may include a count of radio link failures between UE and the base station.

The state of UE may include idle mode or connected mode The idle mode means that UE does not have a request to send or receive data to or from the base station or have the communication with the base station taking place. The connected mode means that UE has a request to send or receive data to or from the base station or has the communication with the base station taking place. The state of UE may include the proximity (e.g., measured by distance) to the base station.

The KPI of an infrastructure resource of the cellular network associated with the base station may include a measurement of the amount, the type, or the categories of radio resources consumed in processes performed by the base station. For example, the KPI of an infrastructure resource of the cellular network associated with the base station may include timing advance command statistics from the past and current occurrence on the cells involved, mobility activity between cells considering successful or failed attempts. The parameters characterizing the KPI may include peak data rates (e.g., downlink-20 gbps, uplink-10 gbps), peak spectral efficiency (e.g. downlink-30 bits/see/Hz, uplink-15 bits/see/Hz), data rate experience by user (e.g., downlink-100 mbps, uplink-50 mbps), area traffic capacity (e.g., downlink-10 Mbits/see/m2 in indoor hotspots), latency (user plane) (e.g., 4 ms for enhanced mobile broadband (eMBB), Ims for ultra-reliable low latency communications (URLLC)), connection density (e.g., 1 million devices/km²), average spectral efficiency (e.g., indoor hotspot—downlink 9/uplink 6.75, dense urban-downlink 7.8/uplink 5.4, rural-downlink 3.3/uplink 1.6), energy efficiency (such as efficient data transmission, low energy consumption) (e.g., 90% reduction in energy usage), reliability (e.g., 1 packet loss out of 100 million packets), mobility (e.g., dense urban-up to 30 kmph, rural-up to 500 kmph), mobility interruption time (e.g., Oms), system bandwidth (e.g., at least 100 MHz, up to 1 GHz for operation in high-frequency bands above 6 GHz). In at least one embodiment, the infrastructure resource is at least one of a dedicated transport resource in a backhaul link or a fronthaul link, a dedicated RF resource instance, customer RAN data, a transport slice pipeline, secure signaling session data, a RU, a RAN resource, or another service in the cellular network.

The periodicity parameter manager 250 may determine whether the monitored parameters satisfy a threshold criterion for generating a new value of a periodicity parameter of a signal broadcasted by the base station of the cellular network. For example, the periodicity parameter manager 250 may determine that when a specific parameter described above (e.g., the peak data rate or average data rate) of the signal reaches or exceeds a threshold value, the monitored parameters satisfy the threshold criterion. As another example, the periodicity parameter manager 250 may determine that when each of several parameters described above (e.g., the peak data rate, the number of connected UE, timing advance, mobility triggers, measurement report, etc.) of the signal reaches or exceeds a threshold value, the monitored parameters satisfy the threshold criterion.

The periodicity parameter manager 250 may dynamically generate, based on the monitored parameters, a value of a periodicity parameter of a signal broadcasted by the base station of the cellular network. In some implementations, the periodicity parameter manager 250 generates the value of the periodicity parameter of the signal responsive to determining that the monitored parameters satisfy a threshold criterion. In some implementations, the periodicity parameter of the signal comprises at least one of: periodicity of a synchronization signal block (SSB), periodicity of channel status information reference signal (CSI-RS), or periodicity of an optional system information block, wherein the optional system information block comprises at least one of: system information block type 2 (SIB2), system information block type 3 (SIB3), system information block type 4 (SIB4), or system information block type 5 (SIB5).

In some implementations, the periodicity parameter manager 250 may determine whether the signal is transmitted through a supplemental downlink channel connected to the first UE. Responsive to determining that the signal is transmitted through a supplemental downlink channel, the periodicity parameter manager 250 may dynamically, based on the plurality of parameters, generate a value higher than a default value of periodicity of a synchronization signal block (SSB) or turn off broadcasting the synchronization signal block (SSB). For example, when the supplemental downlink channel is serving data demand for a downlink request from the first US and does not accept new UE connection, the periodicity parameter manager 250 may send SSB less often than the default situation or even turn off the SSB transmission (because the channel is a supplemental, not primary channel to the first UE, the SSB is not necessary) such that the resource elements that is supposed to carry SSB may be used to carry user data or other data.

In some implementations, the periodicity parameter manager 250 may determine whether the signal is transmitted through a primary (including downlink and uplink) channel connected to the first UE. Responsive to determining that the signal is transmitted through a primary channel, the periodicity parameter manager 250 may dynamically, based on the plurality of parameters, increase a default value of periodicity of a synchronization signal block (SSB). For example, when the primary channel reaches a capacity limit that cannot accept new UE connection, the periodicity parameter manager 250 may send SSB less often than the default situation such that the resource elements that is supposed to carry SSB may be used to carry user data or other data.

In some implementations, the periodicity parameter manager 250 may dynamically, based on the plurality of parameters, generate a value of the periodicity of a channel status information reference signal (CSI-RS). For example, the periodicity parameter manager 250 may dynamically, based on the plurality of parameters, generate a value higher than a preset value of periodicity of channel status information reference signal (CSI-RS) or turn off broadcasting the channel status information reference signal (CSI-RS). In some implementations, the periodicity parameter manager 250 may dynamically, based on the plurality of parameters, generate a value of the periodicity of a synchronization signal block (SSB) and a value of the periodicity of a channel status information reference signal (CSI-RS). For example, the periodicity parameter manager 250 may dynamically, based on the plurality of parameters, generate a value higher than a default value of periodicity of a synchronization signal block (SSB) (or turn off broadcasting the synchronization signal block (SSB)) and generate a value higher than a preset value of periodicity of channel status information reference signal (CSI-RS) (or turn off broadcasting the channel status information reference signal (CSI-RS)).

In some implementations, the periodicity parameter manager 250 may dynamically, based on the plurality of parameters, generate a value higher than a preset value of periodicity of an optional system information block (e.g., periodic optional SIB in FIG. 2) or turn off broadcasting the optional system information block (e.g., periodic optional SIB 265 in FIG. 2 and/or on-demand optional SIB 267), and the optional system information block comprises at least one of: system information block type 2 (SIB2), system information block type 3 (SIB3), system information block type 4 (SIB4), or system information block type 5 (SIB5). For example, since SIB2, SIB3, SIB 4, and/or SIB5 is optional, the periodicity parameter manager 250 may send SIB2, SIB3, SIB 4, and/or SIB5 less often than the preset situation or turn off the SIB2, SIB3, SIB 4, and/or SIB5 transmission such that the resource elements that is supposed to carry SIB2, SIB3, SIB 4, and/or SIB5 may be used to carry user data or other data.

The periodicity parameter manager 250 may apply the value of the periodicity parameter for transmission of the signal to a first user equipment (UE). In some implementations, the periodicity parameter manager 250 may send the signal to first UE using the generated value higher than a default value of periodicity of a synchronization signal block (SSB). In some implementations, the periodicity parameter manager 250 may turn off broadcasting the synchronization signal block (SSB) to the first UE. In some implementations, the periodicity parameter manager 250 may send the signal to first UE using the increased value of periodicity of a synchronization signal block (SSB). In some implementations, the periodicity parameter manager 250 may send the signal to first UE using the generated value higher than a preset value of periodicity of CSI-RS. In some implementations, the periodicity parameter manager 250 may turn off broadcasting the CSI-RS. In some implementations, the periodicity parameter manager 250 may send the signal to first UE using the generated value higher than a preset value of periodicity of SIB 2 (e.g., periodic optional SIB in FIG. 2). In some implementations, the periodicity parameter manager 250 may turn off broadcasting the SIB2 (e.g., periodic optional SIB 265 in FIG. 2 and/or on-demand optional SIB 267) to the first UE. In some implementations, the periodicity parameter manager 250 may send the signal to first UE using the generated value higher than a preset value of periodicity of SIB 3 (e.g., periodic optional SIB in FIG. 2). In some implementations, the periodicity parameter manager 250 may turn off broadcasting the SIB3 (e.g., periodic optional SIB 265 in FIG. 2 and/or on-demand optional SIB 267) to the first UE. In some implementations, the periodicity parameter manager 250 may send the signal to first UE using the generated value higher than a preset value of periodicity of SIB 4 (e.g., periodic optional SIB in FIG. 2). In some implementations, the periodicity parameter manager 250 may turn off broadcasting the SIB4 (e.g., periodic optional SIB 265 in FIG. 2 and/or on-demand optional SIB 267) to the first UE. In some implementations, the periodicity parameter manager 250 may send the signal to first UE using the generated value higher than a preset value of periodicity of SIB 5 (e.g., periodic optional SIB in FIG. 2). In some implementations, the periodicity parameter manager 250 may turn off broadcasting the SIB5 (e.g., periodic optional SIB 265 in FIG. 2 and/or on-demand optional SIB 267) to the first UE.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not- and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a periodicity parameter manager (e.g., the periodicity parameter manager 250 of FIGS. 1 and 2).

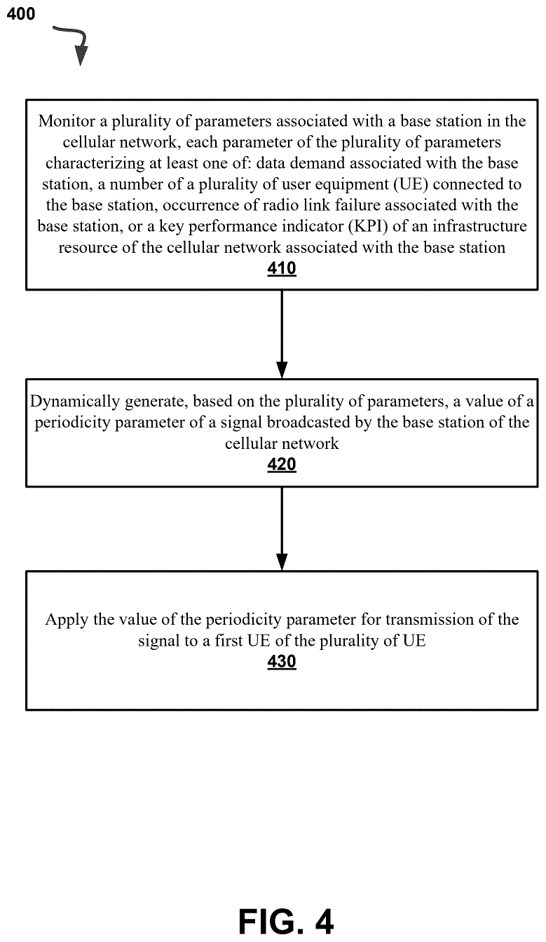

FIGS. 4, 5A-5B, 6 and 7 are flow diagrams of methods 400, 500A, 500B, 600, and 700 of dynamic tuning of signal periodicity in a cellular network according to at least one embodiment. The of methods 400, 500A, 500B, 600, and 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 400, 500A, 500B, 600, and 700 are performed by the system 100 of FIG. 1. In one embodiment, the methods 400. 500A, 500B, 600, and 700 are performed by the periodicity parameter manager 250 of FIG. 1 or 2.

Referring to FIG. 4, at operation 410, the processing logic may monitor one or more parameters associated with a base station in the cellular network, each parameter characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station. In at least one embodiment, the parameters associated with the base station may further include parameters characterizing the state of each user equipment (UE) connected to the base station.

At operation 420, the processing logic may dynamically generate, based on the plurality of parameters, a value of a periodicity parameter of a signal broadcasted by the base station of the cellular network. In at least one embodiment, the periodicity parameter of the signal comprises at least one of: a periodicity of a synchronization signal block (SSB), a periodicity of channel status information reference signal (CSI-RS), or a periodicity of an optional system information block, wherein the optional system information block comprises at least one of: system information block type 2 (SIB2), system information block type 3 (SIB3), system information block type 4 (SIB4), or system information block type 5 (SIB5).

In at least one embodiment, the processing logic may determine whether the plurality of parameters satisfies a threshold criterion, wherein dynamically generating the value of the periodicity parameter of the signal is performed responsive to determining that the plurality of parameters satisfies the threshold criterion.

At operation 430, the processing logic may apply the value of the periodicity parameter for transmission of the signal to a first UE of the plurality of UE. The processing logic may broadcast the signal according to the generated value of a periodicity parameter of the signal. In at least one embodiment, the processing logic may broadcast the SSB according to the generated value of periodicity of SSB. In at least one embodiment, the processing logic may broadcast the CSI-RS according to the generated value of periodicity of CSI-RS. In at least one embodiment, the processing logic may broadcast the SIB2 according to the generated value of periodicity of SIB2. In at least one embodiment, the processing logic may broadcast the SIB3 according to the generated value of periodicity of SIB3. In at least one embodiment, the processing logic may broadcast the SIB4 according to the generated value of periodicity of SIB4. In at least one embodiment, the processing logic may broadcast the SIB5 according to the generated value of periodicity of SIB5.

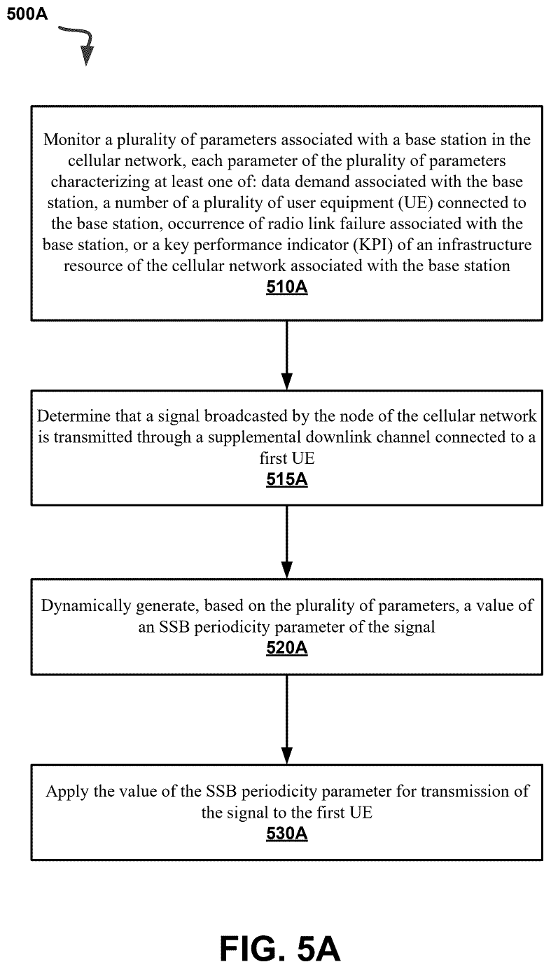

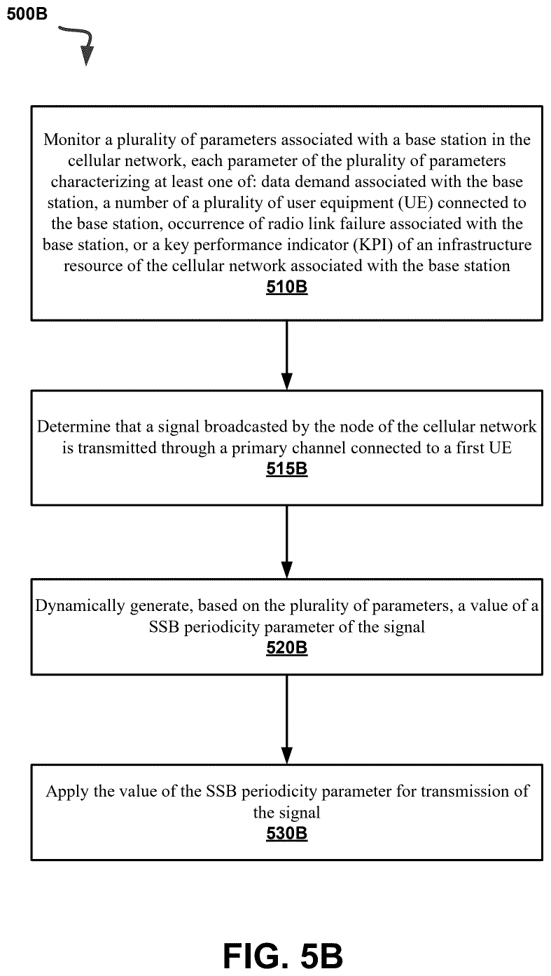

Referring to FIG. 5A, at operation 510A, the processing logic may monitor one or more parameters associated with a base station in the cellular network, each parameter characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station, which may be similar to or same as the operation 410.

At operation 515A, the processing logic may determine that a signal broadcasted by the node of the cellular network is transmitted through a supplemental downlink channel connected to a first UE.

At operation 520A, the processing logic may dynamically generate, based on the plurality of parameters, a value of an SSB periodicity parameter of the signal. In at least one embodiment, the processing logic may generate a value higher than a default value of a periodicity of a synchronization signal block (SSB) and/or turn off broadcasting the SSB (e.g., a value corresponding to turning off).

At operation 530A, the processing logic may apply the value of the SSB periodicity parameter for transmission of the signal to the first UE. The processing logic may broadcast the SSB through the supplemental downlink channel according to the value of the SSB periodicity parameter.

Referring to FIG. 5B, at operation 510B, the processing logic may monitor one or more parameters associated with a base station in the cellular network, each parameter characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station, which may be similar to or same as the operation 410.

At operation 515B, the processing logic may determine that a signal broadcasted by the node of the cellular network is transmitted through a primary (downlink and uplink) channel connected to a first UE.

At operation 520B, the processing logic may dynamically generate, based on the plurality of parameters, a value of an SSB periodicity parameter of the signal. In at least one embodiment, the processing logic may increase a default value of periodicity of a synchronization signal block (SSB).

At operation 530B, the processing logic may apply the value of the SSB periodicity parameter for transmission of the signal to the first UE. The processing logic may broadcast the SSB through the primary (downlink and uplink) channel according to the value of the SSB periodicity parameter.

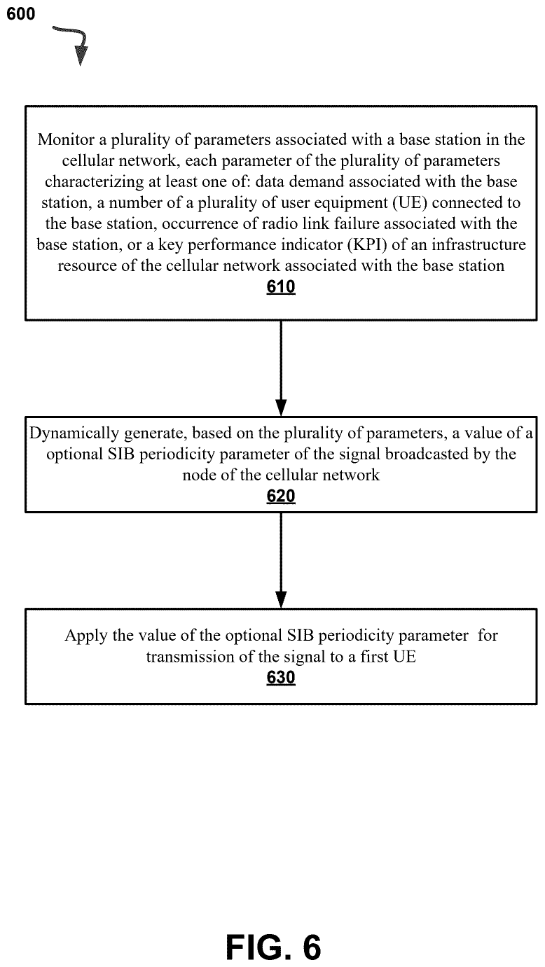

Referring to FIG. 6, at operation 610, the processing logic may monitor one or more parameters associated with a base station in the cellular network, each parameter characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station, which may be similar to or same as the operation 410.

At operation 620, the processing logic may dynamically generate, based on the plurality of parameters, a value of an optional SIB periodicity parameter of the signal. In at least one embodiment, the processing logic may generate a value higher than a preset value of a periodicity of an optional SIB or turn off broadcasting the optional SIB (e.g., a value corresponding to turning off). In at least one embodiment, the processing logic may generate a value higher than a preset value of a periodicity of SIB2 or turn off broadcasting the SIB2. In at least one embodiment, the processing logic may generate a value higher than a preset value of a periodicity of SIB3 or turn off broadcasting the SIB3. In at least one embodiment, the processing logic may generate a value higher than a preset value of a periodicity of SIB4 or turn off broadcasting the SIB4. In at least one embodiment, the processing logic may generate a value higher than a preset value of a periodicity of SIB5 or turn off broadcasting the SIB5.

At operation 630, the processing logic may apply the value of the optional SIB periodicity parameter for transmission of the signal to the first UE. The processing logic may broadcast the optional SIB (e.g., through the primary (downlink and uplink) channel and/or the supplemental downlink channel) according to the value of the optional SIB periodicity parameter. In at least one embodiment, the processing logic may broadcast SIB2 (e.g., through the primary (downlink and uplink) channel and/or the supplemental downlink channel) according to the value of the SIB2 periodicity parameter. In at least one embodiment, the processing logic may broadcast SIB3 (e.g., through the primary (downlink and uplink) channel and/or the supplemental downlink channel) according to the value of the SIB3 periodicity parameter. In at least one embodiment, the processing logic may broadcast SIB4 (e.g., through the primary (downlink and uplink) channel and/or the supplemental downlink channel) according to the value of the SIB4 periodicity parameter. In at least one embodiment, the processing logic may broadcast SIB5 (e.g., through the primary (downlink and uplink) channel and/or the supplemental downlink channel) according to the value of the SIB5 periodicity parameter.

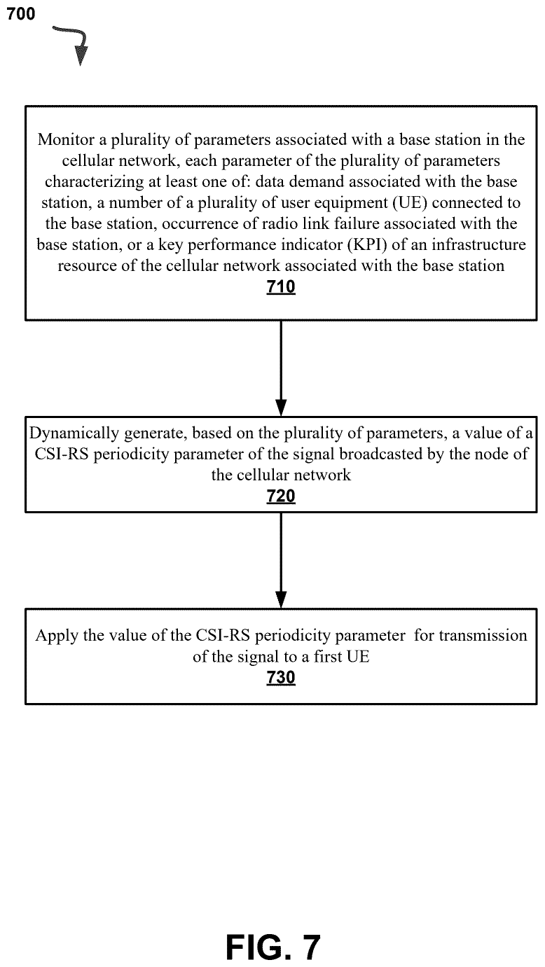

Referring to FIG. 7, at operation 710, the processing logic may monitor one or more parameters associated with a base station in the cellular network, each parameter characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station, which may be similar to or same as the operation 410.

At operation 720, the processing logic may dynamically generate, based on the plurality of parameters, a value of CSI-RS periodicity parameter of the signal. In at least one embodiment, the processing logic may generate a value higher than a preset value of a periodicity of CSI-RS or turn off broadcasting the CSI-RS (e.g., a value corresponding to turning off). In some implementations, the processing logic may dynamically generate, based on the plurality of parameters, a value of CSI-RS periodicity parameter of the signal in addition to generating a value of SSB periodicity parameter as illustrated in operations 520A and 520B.

At operation 730, the processing logic may apply the value of the CSI-RS periodicity parameter for transmission of the signal to the first UE. The processing logic may broadcast the CSI-RS according to the value of the CSI-RS periodicity parameter.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of dynamic tuning of signal periodicity in a cellular network, the method comprising:
monitoring a plurality of parameters associated with a base station in the cellular network, each parameter of the plurality of parameters characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station;
dynamically generating, based on the plurality of parameters, a value of a periodicity parameter of a signal broadcasted by the base station of the cellular network; and
applying the value of the periodicity parameter for transmission of the signal to a first UE of the plurality of UE.

2. The method of claim 1, wherein the periodicity parameter of the signal comprises at least one of: a periodicity of a synchronization signal block (SSB), or a periodicity of a system information block, wherein the system information block comprises at least one of: system information block type 2 (SIB2), system information block type 3 (SIB3), system information block type 4 (SIB4), or system information block type 5 (SIB5).

3. The method of claim 1, further comprising:
determining that the signal is transmitted through a supplemental downlink channel connected to the first UE, wherein dynamically generating, based on the plurality of parameters, the value of the periodicity parameter of the signal further comprises at least one of: generating a value higher than a default value of a periodicity of a synchronization signal block (SSB) or turning off broadcasting the SSB.

4. The method of claim 1, further comprising:
determining that the signal is transmitted through a primary channel connected to the first UE, wherein dynamically generating, based on the plurality of parameters, the value of the periodicity parameter of the signal further comprises increasing a default value of periodicity of a synchronization signal block (SSB).

5. The method of claim 1, wherein dynamically generating, based on the plurality of parameters, the value of the periodicity parameter of the signal further comprises at least one of: generating a value higher than a preset value of a periodicity of a system information block or turning off broadcasting the system information block, wherein the system information block comprises at least one of: system information block type 2 (SIB2), system information block type 3 (SIB3), system information block type 4 (SIB4), or system information block type 5 (SIB5).

6. The method of claim 1, further comprising:
determining whether the plurality of parameters satisfies a threshold criterion, wherein dynamically generating the value of the periodicity parameter of the signal is performed responsive to determining that the plurality of parameters satisfies the threshold criterion.

7. The method of claim 1, wherein the infrastructure resource is at least one of a dedicated transport resource, a dedicated radio frequency (RF) resource instance, customer radio access network (RAN) data, a transport slice pipeline, secure signaling session data, a Radio Unit (RU), a radio access network (RAN) resource, or another service in the cellular network.

8. The method of claim 1, wherein the plurality of parameters further comprises a parameter characterizing a state of each UE of the plurality of UE connected to the base station.

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
monitoring a plurality of parameters associated with a base station in the cellular network, each parameter of the plurality of parameters characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station;
dynamically generating, based on the plurality of parameters, a value of a periodicity parameter of a signal broadcasted by the base station of the cellular network; and
applying the value of the periodicity parameter for transmission of the signal to a first UE of the plurality of UE.

10. The computing system of claim 9, wherein the periodicity parameter of the signal comprises at least one of: a periodicity of a synchronization signal block (SSB), or a periodicity of a system information block, wherein the system information block comprises at least one of: system information block type 2 (SIB2), system information block type 3 (SIB3), system information block type 4 (SIB4), or system information block type 5 (SIB5).

11. The computing system of claim 9, wherein the operations further comprise:
determining that the signal is transmitted through a supplemental downlink channel connected to the first UE, wherein dynamically generating, based on the plurality of parameters, the value of the periodicity parameter of the signal further comprises at least one of: generating a value higher than a default value of a periodicity of a synchronization signal block (SSB) or turning off broadcasting the SSB.

12. The computing system of claim 9, wherein the operations further comprise:
determining that the signal is transmitted through a primary channel connected to the first UE, wherein dynamically generating, based on the plurality of parameters, the value of the periodicity parameter of the signal further comprises increasing a default value of periodicity of a synchronization signal block (SSB).

13. The computing system of claim 9, wherein dynamically generating, based on the plurality of parameters, the value of the periodicity parameter of the signal further comprises at least one of: generating a value higher than a preset value of a periodicity of a system information block or turning off broadcasting the system information block, wherein the system information block comprises at least one of: system information block type 2 (SIB2), system information block type 3 (SIB3), system information block type 4 (SIB4), or system information block type 5 (SIB5).

14. The computing system of claim 9, wherein the operations further comprise:
determining whether the plurality of parameters satisfies a threshold criterion, wherein dynamically generating the value of the periodicity parameter of the signal is performed responsive to determining that the plurality of parameters satisfies the threshold criterion.

15. One or more non-transitory, computer-readable storage media having computer-readable instructions thereon which, when executed by one or more processing devices, cause the one or more processing devices to perform operations comprising:
monitoring a plurality of parameters associated with a base station in a cellular network, each parameter of the plurality of parameters characterizing at least one of: data demand associated with the base station, a number of a plurality of user equipment (UE) connected to the base station, occurrence of radio link failure associated with the base station, or a key performance indicator (KPI) of an infrastructure resource of the cellular network associated with the base station;
dynamically generating, based on the plurality of parameters, a value of a periodicity parameter of a signal broadcasted by the base station of the cellular network; and
applying the value of the periodicity parameter for transmission of the signal to a first UE of the plurality of UE.

16. The one or more non-transitory, computer-readable storage media of claim 15, wherein the periodicity parameter of the signal comprises at least one of: a periodicity of a synchronization signal block (SSB), or a periodicity of a system information block, wherein the system information block comprises at least one of: system information block type 2 (SIB2), system information block type 3 (SIB3), system information block type 4 (SIB4), or system information block type 5 (SIB5).

17. The one or more non-transitory, computer-readable storage media of claim 15, wherein the operations further comprise:
determining that the signal is transmitted through a supplemental downlink channel connected to the first UE, wherein dynamically generating, based on the plurality of parameters, the value of the periodicity parameter of the signal further comprises at least one of: generating a value higher than a default value of a periodicity of a synchronization signal block (SSB) or turning off broadcasting the SSB.

18. The one or more non-transitory, computer-readable storage media of claim 15, wherein the operations further comprise:
determining that the signal is transmitted through a primary channel connected to the first UE, wherein dynamically generating, based on the plurality of parameters, the value of the periodicity parameter of the signal further comprises increasing a default value of periodicity of a synchronization signal block (SSB).

19. The one or more non-transitory, computer-readable storage media of claim 15, wherein dynamically generating, based on the plurality of parameters, the value of the periodicity parameter of the signal further comprises at least one of: generating a value higher than a preset value of a periodicity of a system information block or turning off broadcasting the system information block, wherein the system information block comprises at least one of: system information block type 2 (SIB2), system information block type 3 (SIB3), system information block type 4 (SIB4), or system information block type 5 (SIB5).

20. The one or more non-transitory, computer-readable storage media of claim 15, wherein the operations further comprise:
determining whether the plurality of parameters satisfies a threshold criterion, wherein dynamically generating the value of the periodicity parameter of the signal is performed responsive to determining that the plurality of parameters satisfies the threshold criterion.
